(19) United States
(12) Patent Application Publication
(10) Pub. No.: US 2014/0232923 A1
(43) Pub. Date: Aug. 21, 2014

(54) Device independent color differences

(71) Applicant: HEWLETT-PACKARD DEVELOPMENT COMPANY, LLP, Houston, TX (US)

(72) Inventors: Wei Koh, Palo Alto, CA (US); Melanie Gottwals, Palo Alto, CA (US); Nathan Moroney, Palo Alto, CA (US); Udi Chatow, Palo Alto, CA (US); Gershon Alon, Ness Ziona (IL)

(73) Assignee: HEWLETT-PACKARD DEVELOPMENT COMPANY, LLP, Houston, TX (US)

(21) Appl. No.: 13/772,290

(22) Filed: Feb. 20, 2013

(51) Int. Cl. G09G 5/02

(52) U.S. Cl. CPC G09G 5/02
USPC 348/333.11; 345/594; 345/589

(57) ABSTRACT

In the present disclosure techniques related to display of device independent color differences are described. In examples, a color comparison graphical user interface (GUI) is operated. The GUI displays a color of a sample object. Further, the GUI displays a color of a reference object. Further, the GUI displays a device independent color difference between the sample color and the reference color.

### BACKGROUND

Color is an important consideration for many types of users, including business users, interior decorators, graphic designers, and even home users. For example, interior decorators may want to precisely select paint and other colors. As another example, graphic designers may want to precisely select colors for printing materials that are as varied as promotional materials, magazine articles and advertisements, and so on.

### BRIEF DESCRIPTION OF THE DRAWINGS

In order that the present disclosure may be well understood, various examples will now be described with reference to the following drawings.

FIG. 1 schematically illustrates a graphical user interface according to examples herein.

FIG. 2 is an environment in which examples can be implemented.

FIG. 3 schematically illustrates a physical reference chart that may be used for implementing examples herein.

FIG. 4 is a block representation of elements of a system for implementing examples.

FIG. 5 is a block representation of physical and logical components for implementing various examples.

FIG. 6 is a flowchart for implementing methods according to examples herein.

FIG. 7 is a flowchart for implementing color acquisition methods according to examples herein.

FIG. 8 is a flowchart for implementing methods to display color difference according to examples herein.

FIG. 9 schematically illustrates a graphical user interface according to examples herein.

### DETAILED DESCRIPTION

In the following description, numerous details are set forth to provide an understanding of the examples disclosed herein. However, it will be understood that the examples may be practiced without these details. While a limited number of examples have been disclosed, it should be understood that there are numerous modifications and variations therefrom.

As noted in the background section, color is an important consideration for many different types of users. Determining the color difference between two objects (e.g., a sample object and a reference object) is an important task in many industries such as, but not limited to, print production, plastics formulation, or practically any manufacturing process in which color is involved. A too-high color difference between a sample and a reference may render a manufactured product inacceptable since it might fail to meet customer expectations.

In a more specific context, a common task of print service provides (PSP) during print production is trying to match sample prints to reference prints in order to meet a customer request. Based on color differences between sample prints and reference prints, a PSP may adjust the print parameters and, more specifically, ink amounts being used in the production of the sample prints in order to accomplish a print job that matches the reference print. PSPs may rely on experienced press operators to determine such color differences and, accordingly, set ink amount adjustments in order to make a sample print match a reference print. However, relying on a human expert may be prone to errors and require multiple interactions in the color matching process that may severely impact costs in print production. To enhance process reliability, PSPs may rely on expensive and often complex spectrometer based hardware to perform color difference measurements.

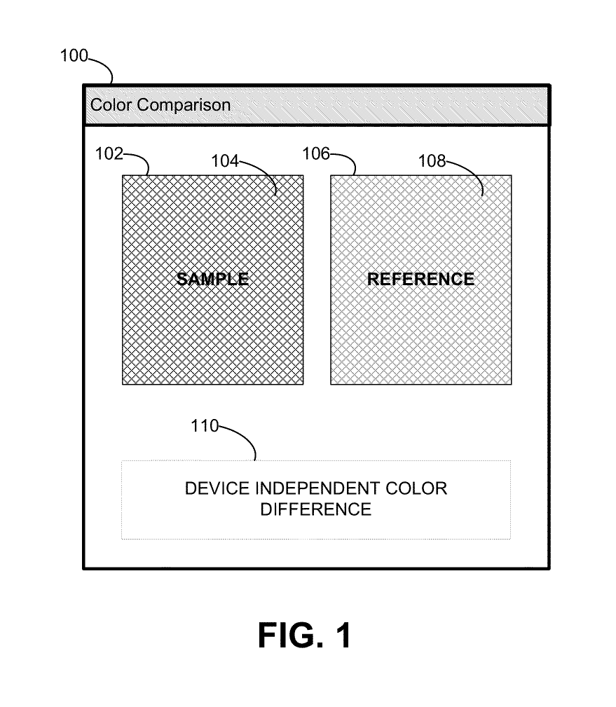

Techniques disclosed herein facilitate overcoming such shortcomings. An example of such techniques is shown in FIG. 1. In the illustrated example, a color comparison graphical user interface (GUI) 100 is provided. GUI 100 is to display a color of a sample object (for example, a sample print). Therefore, GUI 100 may include a sample window 102 to display a reproduction 104 of a color in the sample object. Further, the GUI is to display a color of a reference object (for example, a reference print). Therefore, GUI 100 may include a reference window 106 to display a reproduction 108 of a color in the reference object. GUI 100 is to display a device independent color difference between the sample color and the reference color. For example, GUI 100 may include a color difference window 110 to display the device independent color difference.

As used herein, a device independent color difference refers to a value of the difference between a sample color and a reference color, which value is independent of the nature of the device(s) and imaging conditions (e.g., illumination) used to acquire the colors. The color difference may be displayed as a difference value in a specific space. For example, using the CIELAB color space, the color difference may be displayed as device independent delta E to allow intuitive color difference quantification that is independent of the device, or devices, used to acquire the colors.

Other color spaces such as a RGB color space or, more specifically, a sRGB color space may be used to display the color difference. A device independent color difference may be translated to other devices in a straightforward manner. In examples, the device independent color difference may be displayed as a device colorant metric, i.e. using a color production color model (e.g., a CMYK color model) to allow inferring adjustments required in a print production device for matching the sample with the reference.

Display of a color comparison based on a device independent color difference as described herein provides a reliable and cost-effective method for assessing color differences.

For determining a device independent color difference between the sample color and the reference color, the colors might be measured by using a consistent image-based measurement that takes into account the effects of the imaging system and the scene illuminants. There are a variety of methods for obtaining such image-based measurement. For at least some applications, it is advantageous to use an embedded color calibration chart to determine estimated true colors, i.e. colors obtained by transforming raw image pixel colors into a single corrected space in which device independent colors may be determined. From the estimated true colors, a device independent color difference may be derived as described herein.

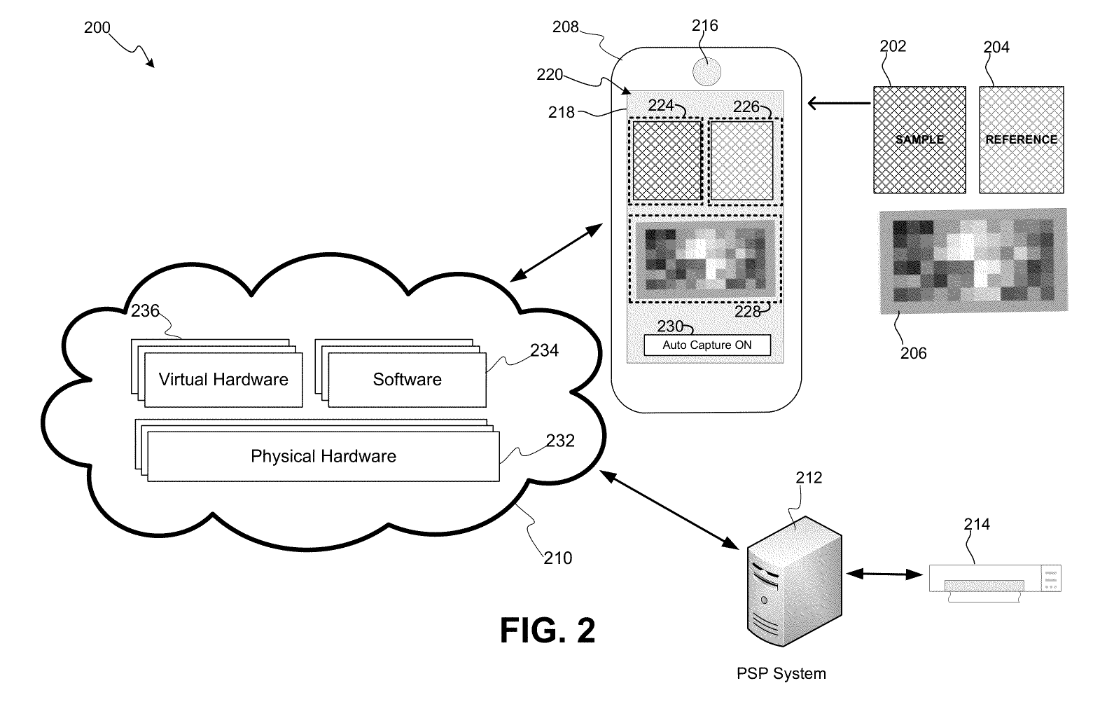

An example environment for obtaining an independent color difference is illustrated in the following with respect to FIG. 2.

FIG. 2 shows an environment 200 in which examples can be implemented. Environment 200 shows a sample object 202, a reference object 204, a color calibration chart 206 (hereinafter referred to as color chart 206), a mobile imaging device 208, a cloud 210, and a print service provider (PSP) system 212 that operates a print production system 214.

An imaging device as used herein, e.g. device 208, might be a dedicated digital imaging camera such as a compact digital camera or an interchangeable lens digital camera or a wearable camera. Further, an imaging device as used herein might be a device dedicated to color profiling. In other examples, an imaging device as used herein might be a multi-use device with advanced computing capabilities such as a smartphone, a tablet, or an interactive TV equipped with a camera.

Mobile imaging device 208 is configured to acquire images via a camera 216. Camera 216 may be used to acquire an image of sample object 202, reference object 204, and color calibration chart 206. Device 208 may include a display 218 to display an image acquisition GUI 220. Display 218 may be a touch panel for allowing user interaction with GUI 220. In the illustrated example, image acquisition GUI 220 is to facilitate to a user acquisition of an image of sample object 202, reference object 204 and color chart 206. Such an image is usable to obtain independent device color comparisons as described below.

In the illustrated example, image acquisition GUI 220 is shown to include a sample overlay 224 to guide the user in the placement of sample object 202. Further, GUI 220 is shown to include a reference overlay 226 to guide the user in the placement of reference object 204. Further, GUI 220 is shown to include a chart overlay 228 to guide the user in the placement of color calibration chart 206. GUI 220 facilitates obtaining a single image containing reproductions of sample object 202, reference object 204, and color chart 206. Device 208 may automatically detect one or more of the reproductions as described below. Alternatively, or in addition to automatic detection, device 208 may allow a user to indicate where the reproductions are located, e.g. by sequentially touching the respective reproductions on display 218 or by touching the respective reproductions on display 218 upon a GUI request. GUI 220 may include a button 230 for selecting the detection mode.

Based on the reproduction of sample object 202, reference object 204, and color chart 206, the reference true color and the sample true color may be both estimated using color correction as described below. These true colors may then be used to determine a device independent color difference as described herein.

It will be understood that there are a variety of methods for using an imaging device to obtain sample colors and reference colors for producing a device independent color chart. These methods are not limited to image acquisition GUI 220. For example, separated images may be acquired from sample object 202 and reference object 204, each of the images with color chart 206 embedded. Further, different color charts may be used for each separated image. From the separated images, both the sample true color and the reference true color may be estimated.

Acquisition using separated objects may be advantageous for comparing distant objects. For example, a sample print may be imaged by a customer at a customer site with an embedded color chart; a reference print may be imaged by PSP with an embedded color chart at the PSP production site; via cloud 210 a device independent comparison may be performed. In another example, a user may want to compare a color of a sample object at one site (e.g., paint color in a wall at home) with a color of a reference object at another site (e.g., available paint colors at a paint shop). The user may acquire images of each object with embedded color charts at each respective site to obtain a device invariant color comparison that is not affected by the different imaging conditions at each site. Thereby, the user may meet a decision based on a reliable color comparison (e.g., buying paint colors that match wall color at home).

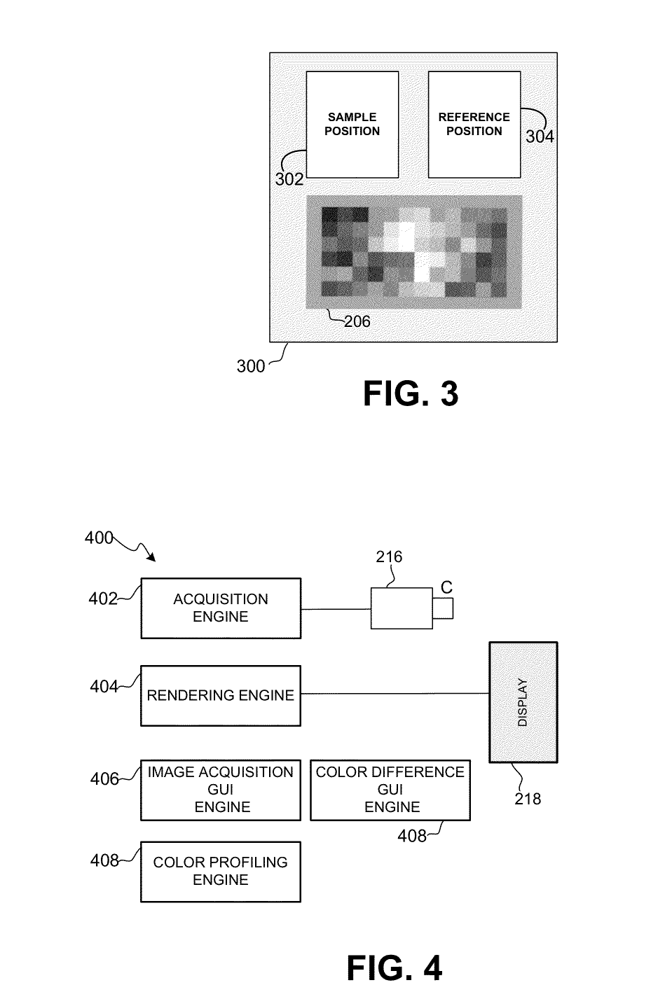

For facilitating the imaging process, in some examples, a physical reference chart may be used that includes a color chart and specific positions for placement of the sample object and reference object. For example, referring to FIG. 3. A physical reference chart 300 may include a color chart 206, a sample position 302 and a reference position 304. Sample position 302 and reference position 304 may be constituted as an open or transparent frame through which the sample and reference are visible.

During operation, physical reference chart 300 may be positioned over sample object 202 and reference object 204. Sample object 202 and reference object 204 may be then located to correspond, respectively, with sample position 302 and reference position 304. Thereby, imaging device 208 may acquire an image of physical reference chart 300 with sample object 202 and reference object 204 being visible at known relative positions from color chart 216 corresponding to sample position 302 and reference position 304. Thereby, it is facilitated single image acquisition and automatic detection of the reproductions of sample, reference, and color chart.

Referring back to FIG. 2, cloud 210 is a computing system including multiple pieces of hardware operatively coupled over a network so that they can perform a specific computing task and, more specifically, deliver services to mobile imaging device 208 such as color measurement services or a request related to a print job (request) via communication with PSP system 212. Cloud 210 includes a combination of physical hardware 232, software 234, and virtual hardware 236. Cloud 210 is configured to (i) receive requests and/or data from mobile imaging device 208, and (ii) return request responses and/or data to mobile imaging device 208 for implementing specific services related to color processing as described above. By way of example, cloud 210 may be a private cloud, a public cloud or a hybrid cloud. Further, cloud 210 may be a combination of cloud computing systems including a private cloud (or multiple private clouds) and a public cloud (or multiple public clouds).

Physical hardware 232 may include, among others, processors, memory devices, and networking equipment. Virtual hardware 236 is a type of software that is processed by physical hardware 232 and designed to emulate specific software. For example, virtual hardware 236 may include a virtual machine (VM), i.e. a software implementation of a computer that supports execution of an application like a physical machine. An application, as used herein, refers to a set of specific instructions executable by a computing system for facilitating carrying out a specific task. For example, an application may take the form of a web-based tool providing users with color profiling capabilities based on an image acquired by mobile imaging device 208. Such color profiling capabilities may include determination of device independent color differences and/or sample-to-reference color matching as described herein.

Software 234 is a set of instructions and data configured to cause virtual hardware 236 to execute an application for providing a color processing service to mobile imaging device 208. Thereby, cloud 210 can make applications related to color profiling, or any other type of service, available to mobile imaging device 208.

PSP system 212 represents an on-premise system of a PSP provider operating print production system 214. PSP system 212 is to provide a color related service to a user of mobile imaging device 208 via cloud 210 such as assessments related to a specific print job (e.g., how well a sample matches a reference produced by print production system 214). Such services may be color profiling for color calibrated communication based on color correction using color chart 206 and print parameters of print production system 214. Thereby, the user of device 208 may establish color calibrated communication to establish sample-to-reference color matching as described herein. For example, reference object 204 may be a reference print associated with print production system 214. A user of device 208 may establish how close a color of sample object 202 matches reference print 204 and, hence, how close sample object 202 may be reproduced by print production system 214. Alternatively, or in addition thereto, a user of device 208 may assess required ink adjustments (and thereby related costs) for an enhanced matching between sample and reference.

In another example, system 204 may be used in a print completion phase for assessing differences between samples being printed and a reference print (e.g., a reference provided by a client). System 204 may be then used to assess print parameter adjustments required for matching the reference. System 204 may communicate with print production system 214 for setting automatically adjustment print parameters.

It will be understood that environment 200 is merely an example and that other environments for implementing examples are foreseen. For example, but not limited thereto, functionality for color profiling may be completely implemented on premises of an imaging device (e.g., mobile imaging device 208). Thereby, the imaging device might be operated independently from a remote computing system (e.g., cloud 210) for implementing functionality described herein.

In the following, elements of systems for implementing examples herein are illustrated. FIG. 4 is a block representation of a system 400 for implementing examples. For illustrating elements shown in FIG. 4, reference is made to the examples in FIGS. 1 to 3. However, it will be understood that elements in FIG. 4 are not limited by these examples and they might be operated in other environments.

System 400 includes camera 216 to acquire an image of sample object 202, reference object 204, and color chart 206. System 400 further includes display 218 to render a color comparison GUI (e.g., color comparison GUI 100 depicted in FIG. 1). Display 218 may be a touch screen that allows user primary operation of the device. Camera 216 and display 218 may be implemented as part of an imaging device such as, but not limited to, mobile imaging device 208.

FIG. 4 also depicts physical and logical components of system 400 for implementing various examples of functionality through a combination of hardware and programming. More specifically, system 400 is shown to include an acquisition engine 402, a rendering engine 404, an image acquisition GUI engine 406, a color comparison GUI engine 408, and a color correction engine 410.

The engines shown in FIG. 4 may be implemented on the premises of an imaging device or via a remote computing system (e.g., cloud 210). For example, acquisition engine 402, rendering engine 404, and image acquisition GUI engine 406 may be implemented on the premises of mobile imaging device 208 and color correction engine 410 may be implemented via cloud 210. Further, individual engines may be implemented via cooperative communication between the imaging device and the cloud. For example, any of the GUIs described herein may be implemented in a web browser or an app delivered via wireless network to a mobile device. Operation of the GUI may, at least partially, reside on cloud 210 using data received from imaging device 208 (e.g., acquired images and user inputs) and delivering data thereto (e.g. results of color profiling). Cloud 210 may also be used to provide data associated with PSP system 212 such as print parameters usable with print production system 214. These print parameters may be used in system 200 for providing functionality related to print production system 214, such as color difference assessment as a device colorant metric. Alternatively, or in addition thereto, data associated with PSP system 212 may be stored in a database of device 208.

Acquisition engine 402 represents, generally, any combination of hardware and programming configured to acquire an image via camera 216. For example, acquisition engine 402 may cause camera 216 to acquire an image of a sample object, a reference object, and a color calibration chart. In examples, acquisition engine 402 may include more specific features such as automatic detection of color chart 206, sample object 202, and reference object 204.

Rendering engine 404 represents, generally, any combination of hardware and programming configured to operate display 218 as a graphical interface. For example, rendering engine 404 may cause rendering of image acquisition GUI 220 and color comparison GUI 100.

Image acquisition GUI engine 406 represents, generally, any combination of hardware and programming configured to operate an image acquisition GUI (e.g., GUI 220). For example, the image acquisition GUI may include the following elements: (i) a sample object GUI element to guide in the acquisition of a sample object (e.g., sample overlay 224); (ii) a reference object GUI element to guide in the acquisition of a reference object (e.g., reference overlay 226); and (iii) a color chart GUI element to guide in the acquisition of a color chart (e.g., chart overlay 228). The image acquisition GUI engine 406 may facilitate acquisition of a single image containing a reproduction of sample object 202, reference object 204, and color chart 206. It will be understood that an image acquisition GUI may include further or alternative elements.

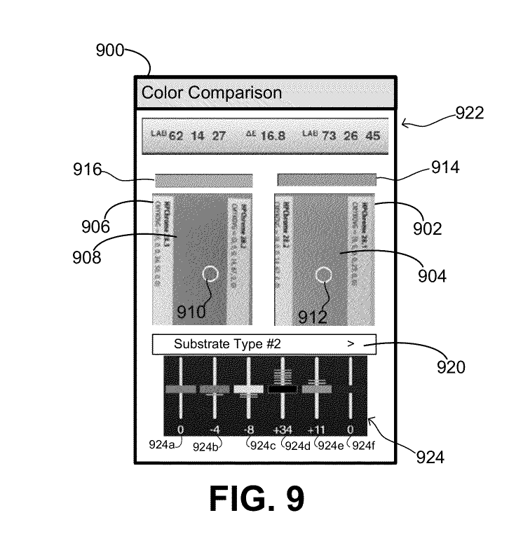

Color comparison GUI engine 406 represents, generally, any combination of hardware and programming configured to operate a color comparison GUI to convey a user a device independent color difference between the sample color and the reference color (e.g., GUI 100). For example, the color comparison GUI may include the following elements: (i) a sample color GUI element displaying a sample color of a color object (e.g., sample window 102); (ii) a reference color GUI element displaying a reference color of a reference object (e.g., reference window 106); and (iii) a color comparison GUI element displaying a device independent color difference between the sample color and the reference color (e.g., color difference window 110). It will be understood that a color comparison GUI may include further elements as illustrated below with respect to FIG. 9.

Color profiling engine 408 represents, generally, any combination of hardware and programming configured to perform a color profile based on a reproduction of color chart 110. It will be understood that there are a variety of methods available for performing color profiling. For example, color profiling engine 408 may be to estimate true colors of sample object 202 or reference object based on the reproduction of color chart 206. In particular, color profiling engine 408 may infer device invariant values from images acquired by camera 216. Color profiling engine 408 may cooperate with color comparison GUI engine 406 for determining device independent color differences based on true colors.

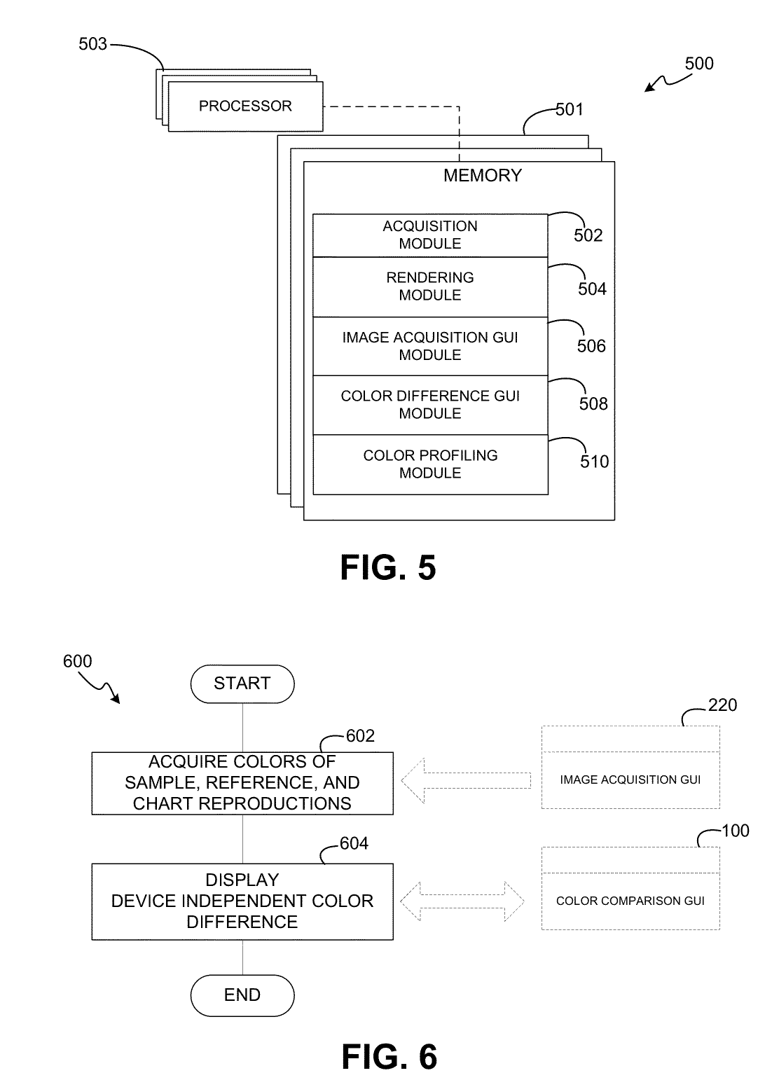

In foregoing discussion, various components were described as combinations of hardware and programming. Such components may be implemented in a number of fashions. Referring to FIG. 5 the programming may be processor executable instructions stored on tangible memory media 501 and the hardware may include a processor 503 for executing those instructions. Memory 301 may be integrated in the same device as processor 303 or it may be separate but accessible to that device and processor 303. Processor 303 may be implemented in mobile computing device 208 or in a remote computing system operatively connected thereto such as cloud 108.

In one example, the program instructions can be part of an installation package that can be executed by processor 503 to implement system 500. In such case, memory 501 may be in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of a tangible computer-readable storage medium that are suitable for storing a program or programs that, when executed, for example by a processor, implement embodiments. Further, memory 501 may be a memory maintained by a server from which the installation package can be downloaded and installed. In another example, the program instructions may be part of an application or applications already installed. Here, memory 501 can include integrated memory such as a hard drive.

Accordingly, examples herein provide a program comprising code for implementing a system or method as claimed in any preceding claim and a tangible or intangible computer readable storage medium storing such a program. A tangible computer-readable storage medium is a tangible article of manufacture that stores data. (It is noted that a transient electric or electromagnetic signal does not fit within the former definition of a tangible computer-readable storage medium.)

Memory 501 can be said to store program instructions that when executed by processor 503 implement at least a portion of examples of systems described herein. For example, the program instructions, when executed, may implement a color comparison GUI and/or an image acquisition GUI according to examples herein. The programming may be implemented as a set of modules, each of the modules, when executed, implementing respective engines in FIG. 4. It will be understood that the illustrated configuration of engines and modules is merely illustrative. Implemented functionality of different engines or modules may be combined into a single engine or module. Further, functionality may be distributed over separated computing entities.

In FIG. 5, the executable program instructions stored in memory 501 are depicted as an acquisition module 502, a rendering module 504, an image acquisition GUI module 506, a color comparison GUI module 508, and a color profiling module 510.

Acquisition module 502 represents program instructions that when executed cause the implementation of acquisition engine 402 of FIG. 4. Likewise, rendering module 504 represents program instructions that when executed cause the implementation of rendering engine 404 of FIG. 4. Likewise, image acquisition GUI module 506 represents program instructions that when executed cause the implementation of image acquisition GUI engine 406 of FIG. 4. Likewise, color comparison GUI module 508 represents program instructions that when executed cause the implementation of color comparison GUI engine 408 of FIG. 4. Likewise, color profiling module 510 represents program instructions that when executed cause the implementation of color profiling engine 510 of FIG. 5.

FIGS. 6 to 8 are exemplary flow diagrams to implement examples herein. In discussing FIGS. 6 to 8, reference is made to the diagrams in FIGS. 1 to 3 to provide contextual examples. Implementation, however, is not limited to those examples. Reference is also made to the example depicted in FIG. 9. Again, such references are made simply to provide contextual examples.

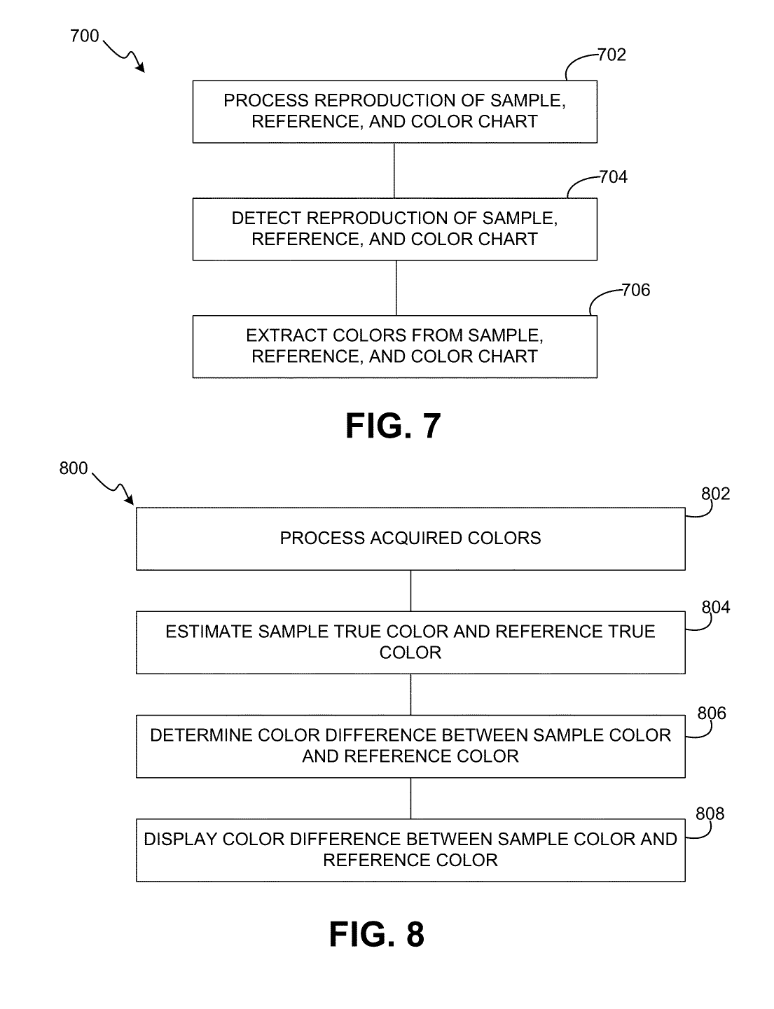

FIG. 6 illustrates a flowchart 600 for implementing methods according to examples herein. At block 602, colors of sample object 202, reference object 204, and color chart 206 are acquired. Data acquired via image acquisition GUI 220 may be used at block 602. Block 602 may be executed in an image acquisition mode executed at imaging device 208, in which mode display 218 renders the image acquisition GUI. Referring to FIG. 4, acquisition engine 402 in conjunction with image acquisition GUI engine 406 may be responsible for implementing block 602. Further details on the acquisition at block 602 are set forth below with respect to FIG. 7.

At block 604, a color difference between a sample color and a reference color is displayed. Data may be exchanged with color comparison GUI 100 at block 604. Block 604 may be executed in a color difference assessment mode executed at imaging device 208, in which mode display 218 renders color comparison GUI 100. Referring to FIG. 4, color profiling engine 402 in conjunction with color comparison GUI engine 406 may be responsible for implementing block 602. Further details on the acquisition at block 604 are set forth below with respect to FIG. 8.

FIG. 7 illustrates a flowchart 700 for acquiring colors of sample object 202, reference object 204, and color chart 206. At block 702 reproductions of a sample object, a reference object, and a color calibration chart are processed. The processing at block 702 may include causing camera 216 to acquire one or more images of sample object 202, reference object 204, and color chart 206 as described above with regard to FIG. 1. Then, digital data representing a reproduction of sample object 202, reference object 204, and color chart 206 may be made available for implementation of further blocks at flowcharts 700 and 800 (depicted in FIG. 8).

At block 704 reproductions of sample object 202, reference object 204, and color chart 206 are detected. As set forth above with respect to FIG. 1, these reproductions may be automatically detected. Alternatively, or in addition thereto, the detection may be accomplished via user interaction.

In an example, a reproduction of color chart 206 is automatically detected from an image acquired via camera 216. There are a variety of methods for automatically detecting a color chart reproduction. For example, a color chart may be automatically detected by identifying pre-defined differences between the standardized colors of the color chart and a color chart background. Alternatively, or in addition thereto, a chart substrate containing the color chart may be provided with an encoding element (e.g., a QR code, not shown) that can be read to automatically detect that a video frame contains a color chart reproduction. Alternatively, or in addition thereto, a color chart may be automatically detected by identifying specific areas of the color chart (e.g., corners of the color chart or locations at a frame surrounding the color patches).

In an example, a reproduction of sample object 202, and reference object 204 are automatically detected from an image acquired via camera 216. There are a variety of manners for automatically detecting a color chart reproduction. For example, referring to physical reference chart 300, color chart 206 may be automatically detected as described above. From the detection of color chart 206, sample object 202, and reference object 204 can be detected since the spatial location of sample position 302 and reference position 304 relative to color chart 206 is known.

At block 706, colors from the reproductions of sample object 202, reference object 204, and color chart 206 are extracted. The colors may be extracted from the digital data composing an acquired object by using the detection at block 704. The extracted colors may be stored for further processing in flowchart 800 of FIG. 8 using a color space of the acquisition device (e.g., mobile imaging device 208). The device color space may be, for example, a standard RGB color space such as a sRGB color space.

FIG. 8 illustrates a flowchart 800 for displaying device independent color differences. A color comparison GUI 900, shown in FIG. 9, is used for illustrating flowchart 700. Color comparison GUI 900 can be seen as a more specific example of color comparison GUI 100 shown in FIG. 1.

At block 802, colors of a sample object and a reference object are processed. Such colors may be processed based on data acquired during flowchart 700.

The processing at block 802 may include rendering a reproduction of the sample object, and the reference object. For example, referring to FIG. 9, a GUI element 902 may be operated to display an image of a sample object 904 (in this example a sample print), and a GUI element 906 may be operated to display an image 908 of a reference object 908 (in this example a reference print). The displayed images of the sample object and the reference object may be color corrected using the acquired color chart in flowchart 700.

The processing at block 802 may further include selecting a color from the sample object and reference color for generating the color comparison. For example, a user may be allowed to interactive select (e.g., by touching display 218) which colors of the sample and reference are to be compared. In the example illustrated in FIG. 9, a user may indicate the sample and reference colors via cursors 910 and 912.

The processing at block 802 may further include displaying the colors of the sample and reference on which the device independent color difference is to be based. In the example of FIG. 9, the colors to be displayed are those selected by the user via cursors 910 and 912 and are displayed by, respectively, GUI element 914 and 916. The displayed colors may be color corrected using the acquired color chart in flowchart 700.

At block 804, a sample true color and a reference true color may be estimated. More specifically, a sample true color may be estimated by color correction based on an image of the sample object acquired along a color calibration chart. Further, a reference true color may be estimated by color correction based on an image of the reference object acquired along a color calibration chart. In some examples, both the sample true color and the reference true color are both estimated by color correction based on a single image containing a reproduction of the sample object, the reference object, and a color calibration chart. Acquisition of such a single image is illustrated above with respect to the environment of FIG. 2.

The estimation of true colors may be performed by color profiling performed based on an embedded color chart in the image(s) of the sample object and the reference object. By color profiling, a color correction function is generated that eliminates a discrepancy between colors measured via the used imaging device and known colors in the color chart. Obtaining such a color correction function is described in, for example, U.S. Pat. No. 7,522,767, which is incorporated herein by reference in its entirety (to the extent in which this document is not inconsistent with the present disclosure) and in particular those parts thereof describing conveying true color of a sample.

The estimation of the true colors may involve determining colors in a device invariant color space such as a Lab color space, based on nonlinearly compressed CIE XYZ color space coordinates. For example, the imaging device may make color data available in a RGB color space, e.g., a sRGB color space. The color correction function may be then used to color correct the imaged colors. Then, the color corrected RGB values may be transformed into the device invariant color space, for example. Lab color values may be thereby obtained in any version of the Lab color space, e.g., the Hunter 1948 L, a, b color space or the CIE 1976 (L*, a*, b*) color space (or CIELAB). In other examples, the true colors may be estimated in print reproduction color spaces, for example a CMYK color space, or in any other suitable color space.

At block 806, a color difference between sample color and reference color is determined. The color difference may be determined in a variety of units.

In some examples, the device independent color difference is determined as a device independent Delta E metric. For example, using the CIE1976 standard, the Delta E metric may be determined as the Euclidean distance between two L*a*b values corresponding to corrected colors of sample and reference. Other definition of the Delta E metric can be used, for examples those of the 1994 and the 2000 revisions of the Lab standard. Color comparison GUI 900 may allow a user to select the units in which the device independent color difference is to be determined via a dedicated unit selector.

In some examples, the device independent color difference is determined as a device colorant metric. A device colorant metric refer to color values calculated using a model of a printing process. For example, an ink model (e.g., a CMYK model) may be used that uses a coordinate for each ink that is available in the printing process. In that case, the device independent color difference corresponds to the set of ink amounts for the sample object matching the reference object. In other words, such a device colorant metric indicates how the ink amounts used to reproduce the sample color are to be modified for producing a replica of the reference color.

For estimating the device colorant metric some print parameters may be taken into account since they may impact the adjustment required for matching the reference color. For example, the type substrate may be taken into account. For example, looking at FIG. 9, a selectable menu 920 may be provided to allow a user to select a substrate type. The selected substrate type is then taken into account for estimating the device colorant metric.

At block 808, the device independent color difference estimated at block 806 is displayed. Values determined at block 806 may be displayed at block 808.

The device independent color difference may be displayed using more than one device independent color difference. For example, referring to FIG. 9, independent color difference may be displayed as a delta E difference and a device colorant metric. In this respect, color comparison GUI 900 provides with a display GUI element 922 that displays Lab values of the sample color displayed at GUI element 914, Lab values of the reference color displayed at GUI element 916, and the corresponding delta E difference between both L*a*b values.

Further, color comparison GUI 900 provides with a display GUI element 924 that displays a visual indication of the color difference in ink amounts required for the sample color to match the reference color. The ink visual indication is comprised of a set of bars 924a-924f (in the illustrated example, the colorant color space corresponds to a print production system with six different ink types). Each bar includes a bar chart 925a-925f indicative of the color difference for a specific ink. Numerical values of the color difference for a specific ink are also provided in each bar.

In the foregoing description, numerous details are set forth to provide an understanding of the examples disclosed herein. However, it will be understood that the examples may be practiced without these details. While a limited number of examples have been disclosed, numerous modifications and variations therefrom are contemplated. It is intended that the appended claims cover such modifications and variations. Further, flow charts herein illustrate specific block orders; however, it will be understood that the order of execution may differ from that which is depicted. For example, the order of execution of two or more blocks may be scrambled relative to the order shown. Also, two or more blocks shown in succession may be executed concurrently or with partial concurrence. Further, claims reciting “a” or “an” with respect to a particular element contemplate incorporation of one or more such elements, neither requiring nor excluding two or more such elements. Further, at least the terms “include” and “comprise” are used as open-ended transitions.

What is claimed is:

1. A computer software product comprising a tangible medium readable by a processor, the medium having stored thereon a set of instructions for operating a color comparison graphical user interface (GUI), the instructions comprising:
a set of instructions which, when loaded into a memory and executed by the processor, causes the GUI displaying a color of a sample object;
a set of instructions which, when loaded into a memory and executed by the processor, causes the GUI displaying a color of a reference object; and
a set of instructions which, when loaded into a memory and executed by the processor, causes the GUI displaying a device independent color difference between the sample color and the reference color.

2. The product of claim 1, wherein the color of the sample object is an estimated true color, the sample true color being estimated by color correction based on an image of the sample object acquired with an embedded color calibration chart.

3. The product of claim 2, wherein the reference color of the reference object is an estimated true color, the reference true color being estimated by color correction based on an image of the reference object acquired with an embedded color calibration chart.

4. The product of claim 3, wherein both the sample true color and the reference true color are both estimated by color correction based on a single image containing a reproduction of the sample object, the reference object, and a color calibration chart.

5. The product of claim 1, wherein the device independent color difference is displayed as a device independent Delta E metric.

6. The product of claim 1, wherein the device independent color difference is displayed as a device colorant metric.

7. The product of claim 6, further comprising a set of instructions which, when loaded into a memory and executed by the processor, causes displaying on the GUI a set of ink amounts for adjustments required for matching the sample color to the reference color.

8. The product of claim 1, further comprising a set of instruction for operating an image acquisition GUI to facilitate acquisition of an image of the sample object, the reference object and a color calibration chart, the image acquisition GUI including:
an overlay to guide the user in the placement of the sample object;
an overlay to guide the user in the placement of the reference object; and
an overlay to guide the user in the placement of the color calibration chart, wherein:
the sample color is an estimated true color of the sample object;
the reference color is an estimated true color of the reference object, and
the reference true color and the sample true color are both estimated by color correction based on the image of the sample object, the reference object and the color calibration chart.

9. A method, comprising:
processing reproductions of a sample object, a reference object, and a color calibration chart;
estimating a true color of the reference object and a true color of the sample reference based on a transformation obtained using the color calibration chart; and
displaying a color difference between the sample true color and the reference true color, whereby the color difference is device independent.

10. The method of claim 9, wherein the reproductions of the sample object, the reference object, and the color calibration chart are from a single image.

11. The method of claim 10 further comprising automatically detecting, in the single image, the reproductions of the sample object, the reference object, and the color calibration chart.

12. The method of claim 9 further comprising computing the color difference as a device independent Delta E metric, wherein the color difference is displayed as the device independent Delta E metric.

13. The method of claim 12 further comprising computing the color difference in a device colorant space, wherein the color difference is further displayed as a colorant difference.

14. The method of claim 9, wherein the sample object is a sample print and the reference object is a reference print.

15. The method of claim 9 further comprising operating a graphical interface (GUI) for acquiring the image, the GUI comprising:
an overlay to guide the user in the placement of the sample object;
an overlay to guide the user in the placement of the reference object; and
an overlay to guide the user in the placement of the color calibration chart.

16. An imaging device comprising:
a camera to acquire an image of a sample object, a reference object, and a color calibration chart;
a display to render a color comparison graphical user interface (GUI);
a processor operatively connected to a memory to operate the color comparison GUI, the color comparison GUI including:
a sample color GUI element displaying a sample color of a color object;
a reference color GUI element displaying a reference color of a reference object; and
a color comparison GUI element displaying a device independent color difference between the sample color and the reference color.

17. The device of claim 16, wherein the color comparison GUI is to allow a user to select the sample color from the display of the sample object and to select the reference color from the display of the reference object.

18. The mobile imaging device of claim 16, wherein the display is a touch screen to allow a user primary operation of the device.

19. The mobile imaging device of claim 16, wherein the color comparison GUI element includes a display element to display a device independent Delta E metric.

20. The mobile imaging device of claim 19, wherein the color comparison GUI element further includes a display element to display a device colorant metric.
